(19) United States
(12) Patent Application Publication
(10) Pub. No.: US 2026/0288294 A1
(43) Pub. Date: Sep. 24, 2026

(54) ONE OR MORE NON-TRANSITORY COMPUTER-READABLE STORAGE MEDIA, INFORMATION PROCESSING SYSTEM, AND COMPUTER IMPLEMENTED METHOD

(71) Applicant: Nintendo Co., Ltd., Kyoto (JP)

(72) Inventors: Masato KOBAYASHI, Kyoto (JP); Masayoshi KODAMA, Kyoto (JP); Ryoma AOKI, Kyoto (JP); Shiro KATO, Kyoto (JP)

(21) Appl. No.: 19/575,750

(22) Filed: Mar. 23, 2026

(30) Foreign Application Priority Data
Mar. 24, 2025 (JP) 2025-048044

(51) Int. Cl. G06F 3/04812

(52) U.S. Cl. CPC G06F 3/04812

(57) ABSTRACT

A first designated position in a first coordinate system is calculated based on mouse sensor data, the first designated position is outputted to an application, based on a request by the application, a second designated position of a predetermined second coordinate system is calculated, based on the first designated position, and a cursor for pointing to the second designated position is rendered, based on a request by an application.

### CROSS REFERENCE TO RELATED APPLICATION

This application claims priority to Japanese Patent Application No. 2025-48044, filed on Mar. 24, 2025, the entire contents of which are incorporated herein by reference.

### FIELD

The present disclosure relates to information processing.

### BACKGROUND AND SUMMARY

Hitherto, it has been known that when applications use a cursor, for example, the cursor is rendered regardless of the application being executed, and each application refers to the position of the rendered cursor, and, if said position is a specified position on an image of the application, executes a process according thereto.

There has been a demand for applications to be able to appropriately use a cursor.

Configuration examples according to the present disclosure will be shown below.

### Configuration Example 1

A configuration example 1 is one or more non-transitory computer-readable storage media having stored therein instructions that, when executed, cause one or more processors to perform operations comprising: calculating a first designated position in a first coordinate system, based on mouse sensor data of an input apparatus; outputting the first designated position to a first application, based on a first request by the first application; calculating a second designated position in a predetermined second coordinate system, based on the first designated position; and rendering a cursor for pointing to the second designated position, based on a second request by the first application.

### Configuration Example 2

In a configuration example 2 based on the above configuration example 1, the first designated position is a position on an image of the first application, and the second designated position is a position in which the rendered cursor is in a display image including the image of the first application, and which corresponds to the first designated position.

### Configuration Example 3

In a configuration example 3 based on the above configuration example 1 or 2, the first coordinate system is settable by the first application, and the operations further comprise calculating the second designated position, based on the first coordinate system set by the first application.

### Configuration Example 4

In a configuration example 4 based on any one of the above configuration examples 1 to 3, the operations further comprise calculating the second designated position, based on a position and/or a size of an image of the first application in a display image.

### Configuration Example 5

In a configuration example 5 based on any one of the above configuration examples 1 to 4, the operations further comprise: shifting a state from a first state in which the cursor is displayed on an image of the first application in a display image, based on a second request by the first application, to a second state in which the cursor is displayed in the display image, based on the second request by a second application; and when performing the shifting, displaying the cursor at a first position which is a position on an image of the second application in the display image in the second state, and in the display image of the cursor in the first state.

### Configuration Example 6

In a configuration example 6 based on any one of the above configuration examples 1 to 5, the operations further comprise: shifting a state from a first state in which the cursor is displayed on an image of the first application in a display image, based on a second request by the first application, to a second state in which the cursor is displayed in the display image, based on the second request by the second application; and when performing the shifting, if a position of the cursor in the display image in the first state is outside an image of the second application in the display image in the second state, displaying the cursor at a first position which is a position of an inner edge area on an image of the second application in the display image.

### Configuration Example 7

In a configuration example 7 based on the above configuration example 5 or 6, the operations further comprise, when performing the shifting, correcting the first designated position such that the cursor is displayed at the first position.

Each configuration example described above may be read as a configuration example of an information processing system or a computer implemented method.

### BRIEF DESCRIPTION OF THE DRAWINGS

FIG. 1 is a block diagram showing a non-limiting example of the internal configuration of a game apparatus 10;

FIG. 2 is a schematic view showing a non-limiting example of an outer appearance of a controller 15;

FIG. 3 illustrates a non-limiting example of a way of holding the controller 15;

FIG. 4 illustrates a non-limiting example of a function block diagram of the game apparatus 10;

FIG. 5 illustrates a non-limiting example of mouse cursor display;

FIG. 6 illustrates a non-limiting example of mouse cursor display;

FIG. 7 illustrates a non-limiting example of mouse cursor display;

FIG. 8 illustrates a non-limiting example of mouse cursor display;

FIG. 9 shows a non-limiting example of various data stored in a storage section (memory) 12; and

FIG. 10 shows a non-limiting example of a flowchart of information processing.

### DETAILED DESCRIPTION OF NON-LIMITING EXAMPLE EMBODIMENTS

Hereinafter, an exemplary embodiment will be described.

### Hardware Configuration of Information Processing Apparatus

An information processing system for executing information processing according to the exemplary embodiment will be described. This information processing system is an information processing apparatus such as a game apparatus, a personal computer, a tablet terminal, a smartphone, a wearable terminal, or a server, for example. The information processing system according to the exemplary embodiment may be composed of a plurality of information processing apparatuses, or may be composed of a game apparatus or the like as described above, and a server, for example. In the exemplary embodiment, a game apparatus will be described as an example of the information processing system and the information processing apparatus.

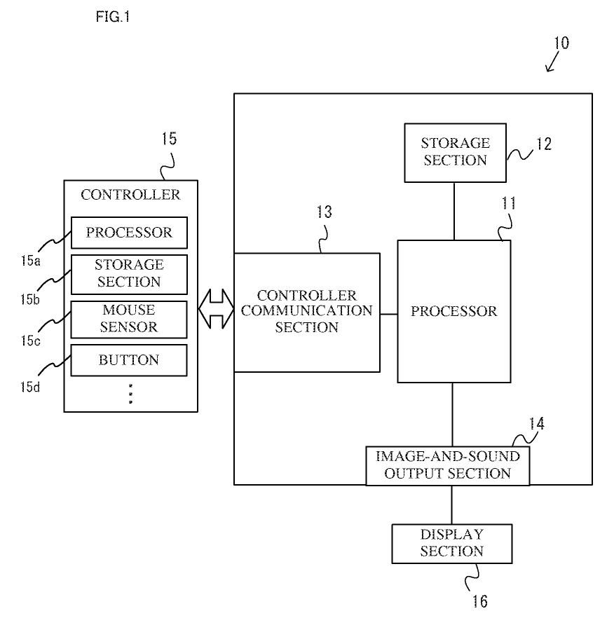

FIG. 1 is a block diagram showing an example of the internal configuration of a game apparatus 10 according to the exemplary embodiment. The game apparatus 10 includes a processor 11. The processor 11 is an information processing section for executing various information processes to be executed on the game apparatus 10. The processor 11 may be composed of a plurality of processors and cores, typically, a plurality of CPUs (Central Processing Units) and cores, or may be composed of a SoC (System-on-a-chip) including a plurality of functions such as a CPU function and a GPU (Graphics Processing Unit) function, for example. The processor 11 executes various information processes by executing an information processing program (e.g., a game program) stored in the storage section 12. The storage section 12 may be an internal storage medium such as a flash memory or a DRAM (Dynamic Random Access Memory), or may be an external storage medium attached to a slot (not shown), or the like. In the exemplary embodiment, the term “processor” may include at least a CPU, a GPU, an ASIC (Application Specific Integrated Circuit), an FPGA (Field Programmable Gate Array), and the like. In the exemplary embodiment, the computer includes at least one processor, as an example, and may further include a storage section such as a memory. In a case where the information processing system includes a plurality of information processing apparatuses, each information processing apparatus may include at least one processor and may include a storage section.

The game apparatus 10 includes a controller communication section 13 for performing at least wireless communication with a controller 15. The controller communication section 13 may control wired communication between the game apparatus 10 and the controller 15 which is an input apparatus. The controller communication section 13 may be included in the processor 11.

A display section 16 (e.g., display) is connected to the game apparatus 10 via an image-and-sound output section 14. The processor 11 outputs an image and a sound generated through execution of the information processing, to the display section 16 capable of outputting also a sound, via the image-and-sound output section 14.

The controller 15 includes a mouse sensor 15c. The mouse sensor 15c acquires data that allows calculation of movement and the like of the controller 15 through a mouse operation. The data is repeatedly transmitted to the controller communication section 13 at appropriate timings.

The controller 15 includes a button 15d. Data indicating that the button 15d has been operated is repeatedly transmitted to the controller communication section 13 at appropriate timings.

The controller 15 includes a processor 15a and a storage section 15b. The processor 15a, for example, can acquire output data from the mouse sensor 15c and the button 15d, and can perform various processes by using the acquired data. For example, the processor 15a can determine various operations performed on the controller 15 by using the acquired data.

The controller 15 and the display section 16 may be considered to be included in the game apparatus 10 or may be considered not to be included in the game apparatus 10.

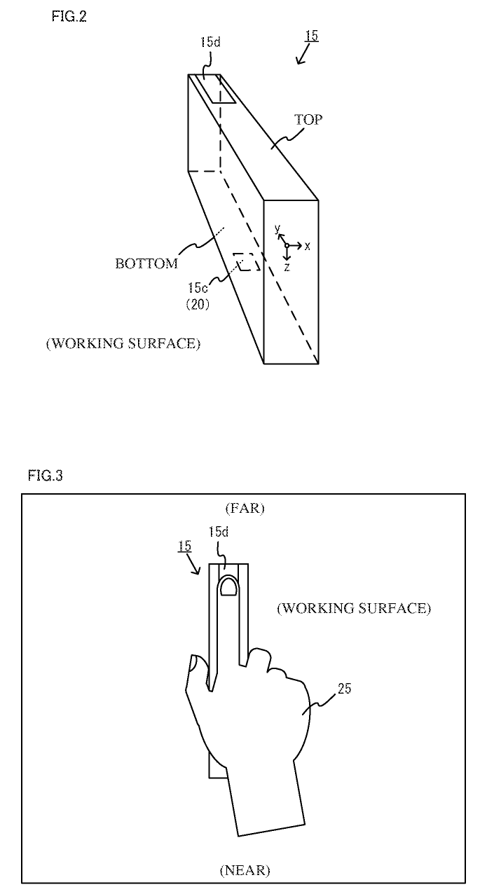

FIG. 2 is a schematic view showing an example of the outer appearance of the controller 15. As shown in FIG. 2, the controller 15 has, as an example, a plate shape in which the y-axis direction is the longitudinal direction (a rectangular parallelepiped or a similar shape in which the thickness in the x-axis direction is smaller than the thickness in the y-axis direction and the thickness in the z-axis direction, and the thickness in the z-axis direction is smaller than the thickness in the y-axis direction) (see xyz coordinate system in FIG. 2). The controller 15 may have another shape.

As shown in FIG. 2, the controller 15 has an opening 20 for a mouse sensor, at the bottom. The opening 20 for a mouse sensor is an opening of a light guide path through which light is guided to the mouse sensor 15c provided inside the opening 20. The mouse sensor 15c may be an optical mouse sensor and may include a light emitting portion and a light receiving portion, for example. Light to be detected by the light receiving portion may be visible light or invisible wavelength light. The mouse sensor 15c acquires data that allows calculation of movement or the like, on a working surface of the controller 15 placed with its bottom facing the working surface. Thus, the controller 15 can be used also as a mouse. An operation for use as a mouse may be referred to as “mouse operation”. The mouse sensor may be a type of a sensor that detects movement of a trackball, for example.

As shown in FIG. 2, the controller 15 includes a button 15d. The button 15d is provided at the top opposite to the bottom, for example. The button 15d may be provided at a side portion located between the bottom and the top, on the far side when the user performs a mouse operation using the controller 15, or may be provided extending from the side portion to the top. Data indicating the operation state of the button 15d is repeatedly transmitted to the controller communication section 13 at appropriate timings.

### Example of Holding Manner for Controller

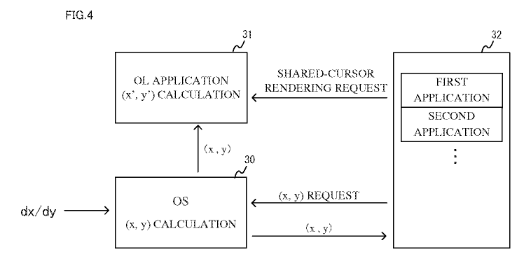

FIG. 3 is a schematic view showing an example of a state in which the user is holding the controller 15 by a right hand 25 and uses the controller 15 placed on the working surface as a mouse, i.e., a state of performing a mouse operation. As shown in FIG. 3, the user can perform a mouse operation of moving the controller 15 on the working surface, and can press the button 15d by the index finger or the middle finger.

### Outline of Information Processing in Exemplary Embodiment

Next, the outline of information processing executed by the game apparatus 10 according to the exemplary embodiment will be described. In the information processing, an image of one or more applications (the application may be referred to as “app”, and the image may be referred to as “app image”) can be displayed on a display screen such as a display section 16. In the information processing, a mouse cursor shared by a plurality of applications (may be referred to as “shared cursor”) can be displayed on the display screen and an operation by the user can be accepted by using the shared cursor. In addition, for example, even when an app image displayed on the display screen is displayed in a reduced manner, or an operation target application has been switched, an operation using the shared cursor can be appropriately executed.

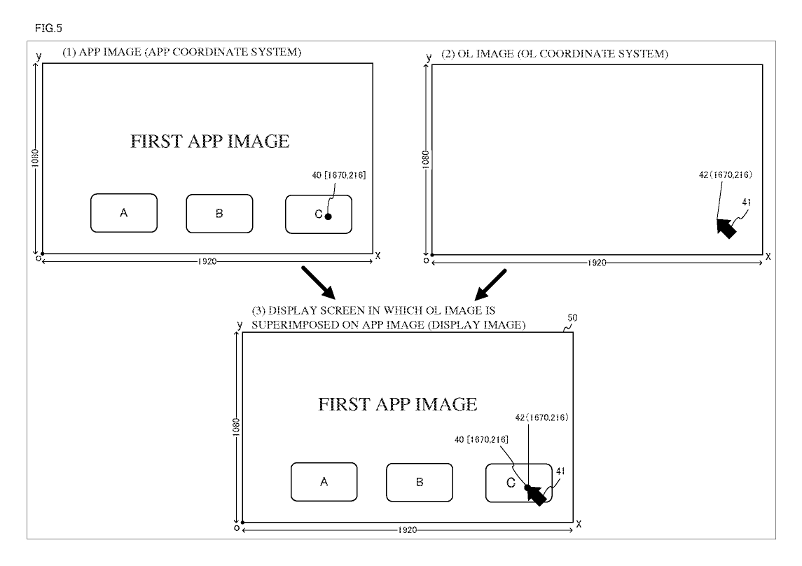

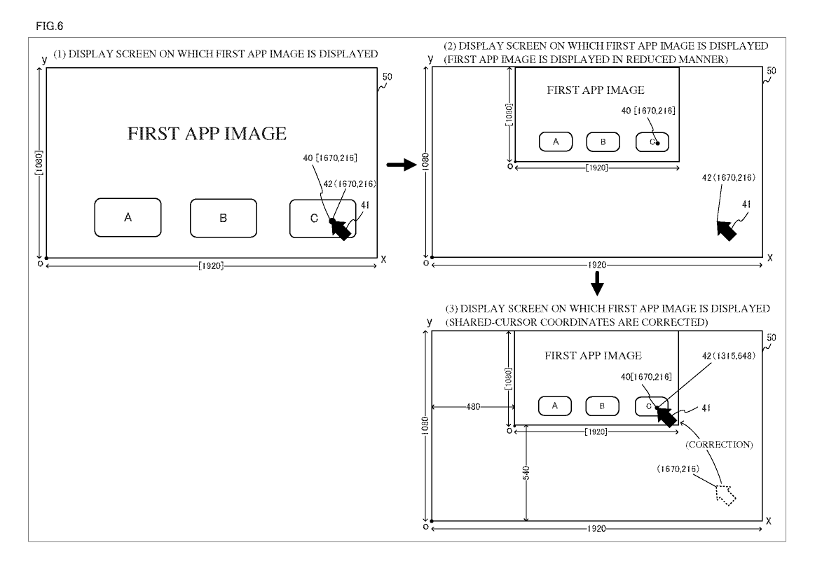

FIG. 4 is an example of a function block diagram of the game apparatus. FIG. 5 illustrates control of the shared cursor.

In FIG. 4, dx/dy data (may be simply referred to as ”dx/dy”) is output data from the mouse sensor 15c, and is data that indicates a movement distance per frame time in the x-axis direction and the y-axis direction (see FIG. 2) of the controller relative to the working surface or the like when the opening 20 for the mouse sensor 15c is closed by the working surface or the like.

An operating system (may be referred to as “OS”) 30 calculates app mouse coordinates (may be referred to as “(x, y)”) by adding the dx/dy. The app mouse coordinates are coordinates that are for performing an operation by the shared cursor in an image of an application 32 (may be referred to as “app image”), and are in a coordinate system that specifies the app image (may be referred to as “app coordinate system”). The app mouse coordinates may be used for an operation by a cursor specific to the application 32, or may be used for an operation by the shared cursor, for example.

The application 32 is an application executed by a processor 11, and is, for example, a game application for executing game processing, a chat application for performing chat among users, a setting application for performing setting for the game apparatus, the game application, or the like. In FIG. 4, as the application 32, a plurality of applications such as a first application and a second application are illustrated. Hereinafter, with reference to FIG. 4 and FIG. 5, a case where the first application as the operation target is displayed on a display screen 50 will be described as an example.

As shown in FIG. 4, in a case of accepting a user operation using the shared cursor, the first application requests the (x, y) from the OS 30, and in response thereto, the OS 30 outputs the (x, y) to the first application, as an example. In the exemplary embodiment, the OS 30 constantly calculates the (x, y). In the other embodiments, the OS 30 may calculate the (x, y) upon request from the application 32, and output the (x, y) to the application 32.

The first application can perform, by using the received (x, y), a process according to an operation input by the user. For example, when the button 15d of the controller 15 is operated in a state in which the app mouse coordinates (x, y) are positioned in the area of a button displayed in the app image of the first application (may be referred to as “first app image”), the first application executes a process associated with said area (typically, a process according to a click operation). In the exemplary embodiment, the app mouse coordinates are internal values and are not directly displayed. The shared cursor displayed in accordance with the app mouse coordinates are described later.

FIG. 5(1) shows a first app image. As shown in FIG. 5(1), the first app image is an image specified by an app coordinate system having an x-axis direction dimension of 1920 and a y-axis direction dimension of 1080. That is, the first app image is an image of a [1920×1080] app coordinate system. Thus, the first app image can be considered as a first app coordinate system. The first app image includes the display of buttons A to C. In FIG. 5(1), app mouse coordinates 40 are positioned within the area of the button C, and the values of the app mouse coordinates 40 are [1670, 216]. The app mouse coordinates 40 indicated as a point in FIG. 5(1) are not actually displayed.

FIG. 5(2) shows an OL image rendered by an overlay (may be referred to as “OL”) app 31. As shown in FIG. 5(2), the OL image is an image specified by an OL coordinate system having an x-axis direction dimension of 1920 and a y-axis direction dimension of 1080. That is, the OL image is an image of the OL coordinate system having a fixed size of [1920×1080]. In the OL image, an arrow-shaped shared cursor 41 is displayed. When the shared cursor 41 is in the arrow shape, the position of the tip of the arrow is an example of the coordinates pointed by the shared cursor 41. The coordinates pointed by the shared cursor 41 may be referred to as shared-cursor coordinates 42. The shape of the shared cursor is not limited thereto.

As shown in FIG. 5(3), a superimposed image in which the OL image is superimposed on top of the app image is displayed on the display screen 50 as a display image. It is noted that a point is rendered at the app mouse coordinates, but the point may not necessarily be displayed on the actual display screen 50. The same is true for the other drawings showing the display screen 50. The display size of the OL image displayed on the display screen 50 is fixed to the size of [1920×1080] (i.e., the same size as the size of the display image of the display screen 50). Meanwhile, the display size of the app image displayed on the display screen 50 is variable within a size equal to or smaller than that of the display image of the display screen. FIG. 5(3) shows a case where the display size of the app image of the first application is the same as the size of the display screen.

For the user to appropriately execute an operation through the shared cursor 41, the position defined by the app mouse coordinates 40 in the app coordinate system and the position defined by the shared-cursor coordinates 42 in the OL coordinate system need to coincide on the display screen 50. Thus, as shown in FIG. 5, the values of the shared-cursor coordinates 42 need to be the same values as the values [1670, 216] of the app mouse coordinates 40.

The OL application 31 constantly calculates the shared-cursor coordinates (may be referred to as “(x’, y’)”), based on the (x, y) calculated by the OS 30. In the case shown in FIG. 5(3), since the first app image and the OL image are superimposed on each other in the same display size and displayed on the display screen 50, the OL application 31 calculates the values (1670, 216) of the shared-cursor coordinates 42 which are the same values as the values [1670, 216] of the app mouse coordinates 40. Then, the OL application 31 renders the OL image in response to a request from the first application to render the shared cursor. The first application, the OL application 31, or the OS 30 causes the OL image to be superimposed on top of the first app image.

In the above description, for convenience of explanation, a case where the app image (i.e., the app coordinate system) and the OL image (i.e., the OL coordinate system) have the same size of [1920×1080] has been described. However, the size of the app coordinate system can be set by the application, and may differ depending on the application. When the size of the app coordinate system differs from the size of the OL coordinate system, the OL application 31 adjusts the values of the shared-cursor coordinates (x’, y’) by using the ratio between the size of the app coordinate system and the size of the OL coordinate system. For example, a case where the size of the first app image is [1280×720] is assumed. In this case, regarding the shared-cursor coordinates, the OL application 31 adjusts the values of the shared-cursor coordinates by multiplying x’ by 1920/1280 and multiplying y’ by 1080/720. Thus, even when the size of the coordinate system for the app image differs from the size of the coordinate system for the OL image, the position defined by the app mouse coordinates 40 coincides with the position defined by the shared-cursor coordinates 42 on the display screen 50 as with FIG. 5(3), thereby enabling an appropriate process.

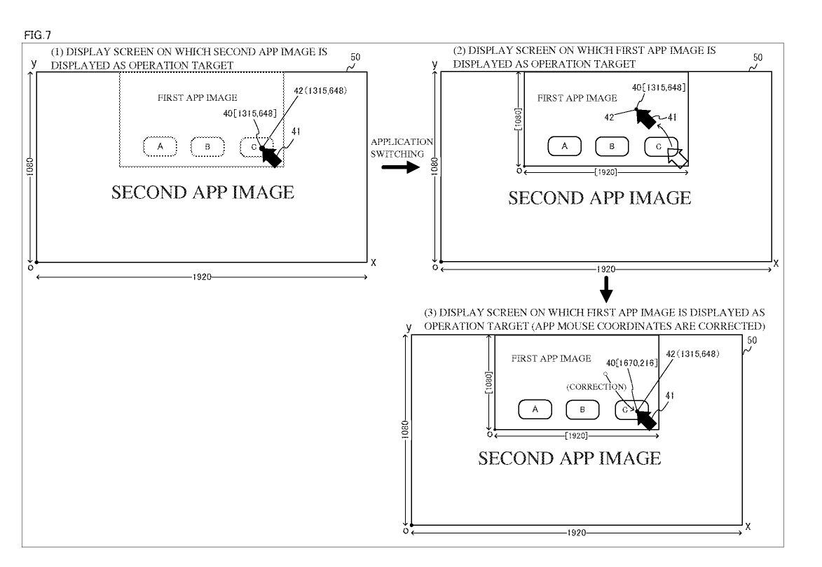

FIG. 6 illustrates a case where the app image displayed on the display screen is displayed in a reduced manner. FIG. 6(1) shows the same state as that in FIG. 5(3). FIG. 6(2) shows a state in which the display size of the first app image is reduced from that in the state in FIG. 6(1) in accordance with an operation or the like by the user. In FIG. 6(2), as an example, the first app image is reduced to 50% in display size and is disposed at the center in the left-right direction of the display screen 50 and at a position in contact with the upper side of the display screen 50.

Here, since the first app image is displayed in a reduced manner, the position defined by the app mouse coordinates 40 is deviated from the display position defined by the shared-cursor coordinates 42 on the display screen 50, as shown in FIG. 6(2). When a decision operation is performed by the user pressing the button 15d in this state, for example, a process corresponding to the area of the button C in the first application is executed despite the fact that the shared cursor 41 is pointing to an area unrelated to the first application.

Therefore, in such a case, the OL application 31 calculates, based on the display position and the reduction rate of the display size of the reduced app image, shared-cursor coordinates in which the deviation is corrected. Specifically, as shown in FIG. 6(3), the OL application 31 corrects the position of the shared cursor 41 such that the position defined by the shared-cursor coordinates 42 coincides with the position defined by the app mouse coordinates 40 on the display screen 50.

In the case shown in FIG. 6(3), the first app image is vertically and horizontally reduced to 50% in display size, and is disposed at the center in the left-right direction of the display screen 50 and at a position in contact with the upper side of the display screen 50. Hence, as understood from FIG. 6(3), the corrected position defined by the shared-cursor coordinates 42 is (1670, 216)×1/2+(480, 540)=(1315, 648).

In the above description, a case where the display size of the app image is reduced from the display size of the display screen is described as an example. In a case where the display size of the app image is enlarged, through a similar process, the deviation between the display position defined by the app mouse coordinates 40 and the display position defined by the shared-cursor coordinates 42 can be appropriately corrected as well, thereby appropriately displaying the shared cursor.

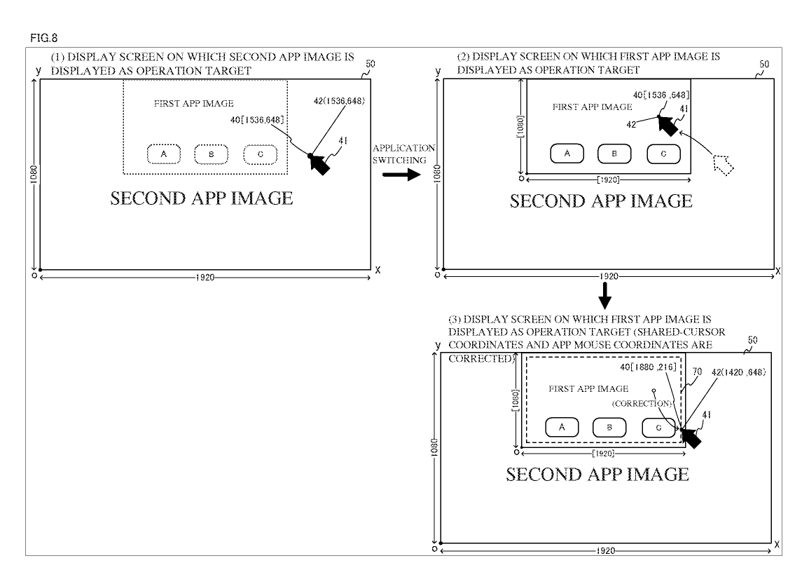

FIG. 7 illustrates a case where the app image of the operation target is switched on the display screen 50 (which can be said as a case where the application as the operation target is switched). FIG. 7(1) shows a state in which an app image of a second application (may be referred to as “second app image”) is the operation target on the display screen 50. In other words, FIG. 7(1) shows a state in which the second application is the operation target. FIG. 7(1) shows an example in which the second app image is displayed in a superimposed manner on top of the first app image, and the first app image faintly appears. The first app image may be displayed or may not be displayed on the display screen 50. As with the first app image, the second app image is an image of a [1920×1080] app coordinate system specified by the app coordinate system having an x-axis direction dimension of 1920 and a y-axis direction dimension of 1080. Thus, the second app image can be considered as a second app coordinate system. The second app image is displayed on the display screen 50 in the same display size as that of the display screen 50. As with FIG. 6(2), the first app image is vertically and horizontally reduced to 50% of the display size of the display screen 50, and is disposed at the center in the left-right direction of the display screen 50 and at a position in contact with the upper side of the display screen 50.

As shown in FIG. 7(1), the OL image is superimposed on top of the second app image, and the shared cursor 41 is displayed. On the display screen 50, the shared-cursor coordinates 42 are located at the position defined by the app mouse coordinates 40 of the second app image. The values [1315, 648] of the app mouse coordinates 40 of the second app image (i.e., the second app coordinate system) and the values (1315, 648) of the shared-cursor coordinates 42 of the OL image (i.e., the OL coordinate system) are illustrated in FIG. 7(1).

FIG. 7(2) shows a state in which the application as the operation target is switched from the second app image to the first app image in accordance with an operation or the like by the user, and the first app image is disposed on top of the second app image, as an example.

Upon switching the operation target to the first app image, the position defined by the app mouse coordinates 40 on the display screen 50 is changed in accordance with the position and the size of the display area of the first app image while maintaining the values [1315, 648] of the app mouse coordinates 40. As described with reference to FIG. 6, the shared-cursor coordinates 42 are corrected in accordance with the position and the size of the display area of the first app image such that the shared cursor 41 points to the position corresponding to the app mouse coordinates 40 on the display screen 50. As a result, as shown in FIG. 7(2), the position defined by the app mouse coordinates 40 and the position defined by the shared-cursor coordinates 42 coincide on the display screen 50.

When the state is shifted from the state in FIG. 7(1) to the state in FIG. 7(2), the displayed shared cursor 41 moves without an operation by the user, which may cause the user to feel a sense of strangeness. Therefore, the OS 30 may correct the app mouse coordinates 40 at the time of switching the operation target from the second app image to the first app image if the shared-cursor coordinates 42 before switching the operation target are located within the area of the first app image that is the operation target after the switching.

Specifically, as shown in FIG. 7(3), the OS 30 may correct the app mouse coordinates 40 such that the app mouse coordinates 40 in the first app image coincide with the position defined by the shared-cursor coordinates 42 (see FIG. 7(1)) on the display screen 50. The corrected app mouse coordinates can be calculated by the process inverse of that described with reference to FIG. 6(3), i.e., can be calculated as ((1315, 648)-(480, 540))×2=(1670, 216). Thus, the app mouse coordinates 40 in the first app image are corrected from [1315, 648] to [1670, 216], and as a result, the position defined by the app mouse coordinates 40 and the position defined by the shared-cursor coordinates 42 coincide on the display screen 50. Accordingly, it is possible to appropriately perform control using the shared cursor while maintaining the display position of the shared cursor 41 on the display screen 50, when the operation target has been switched from the second app image to the first app image.

A similar process may be executed in a case where the state shown in FIG. 7(3) in which the operation target is the first app image is switched to the state shown in FIG. 7(1) in which the operation target is the second app image. That is, the OS 30 may correct the app mouse coordinates 40 such that the position defined by the app mouse coordinates 40 coincides with the position defined by the shared-cursor coordinates 42 on the display screen 50 while maintaining the shared-cursor coordinates 42.

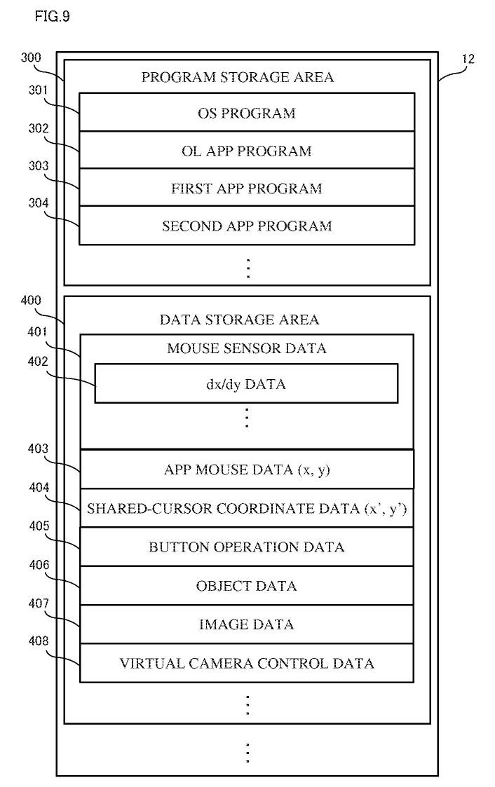

FIG. 8 illustrates another case of switching the app image of the operation target on the display screen 50. FIG. 8(1) shows the display screen 50 in the same state as with FIG. 7(1). However, FIG. 8(1) differs from FIG. 7(1) in that the position defined by the shared-cursor coordinates 42 and the position defined by the app mouse coordinates 40 in the second app image are present outside the display area of the first app image that is later switched to. In FIG. 8(1), the values [1536, 648] of the app mouse coordinates 40 in the second app image and the values (1536, 648) of the shared-cursor coordinates 42 in the OL image are illustrated.

FIG. 8(2) shows a state in which the application as the operation target is switched from the second app image to the first app image in accordance with an operation or the like by the user, and the first app image is disposed on top of the second app image, as an example.

Here, when the state is shifted from the state in FIG. 8(1) to the state in FIG. 8(2), the displayed shared cursor 41 moves a long distance without an operation by the user, which may cause the user to feel a sense of strangeness. Therefore, at the time of switching the operation target from the second app image to the first app image, the OS 30 may correct the app mouse coordinates 40 if the shared-cursor coordinates before switching the operation target are positioned outside the area of the first app image that is the operation target after the switching.

Specifically, as shown in FIG. 8(3), the OS 30 calculates, as the shared-cursor coordinates 42, coordinates that are in the inner edge area in the first app image and are closest to the current shared-cursor coordinates 42 (see FIG. 8(1)) on the display screen 50. For example, a rectangular virtual line 70 located at a specified distance (e.g., a dimension of 40 based on the first app coordinate system) from the upper, lower, right, and left ends of the first app image is set, and the OS 30 calculates coordinates that are the closest to the current shared-cursor coordinates 42 on the virtual line 70 on the display screen 50. In FIG. 8(3), the coordinates (1420, 648) are calculated as the shared-cursor coordinates 42.

As shown in FIG. 8(3), the OS 30 corrects the app mouse coordinates 40 such that the position defined by the app mouse coordinates 40 coincides with the position defined by the shared-cursor coordinates 42 (1420, 648) on the display screen 50. In FIG. 8(3), the app mouse coordinates in the first app image are corrected from (1536, 648) to (1880, 216). As a result, the position defined by the app mouse coordinates 40 coincides with the position defined by the shared-cursor coordinates 42 on the display screen 50. Accordingly, it is possible to appropriately perform control using the shared cursor while minimizing the movement distance of the shared cursor.

### Details of Information Processing in Exemplary Embodiment

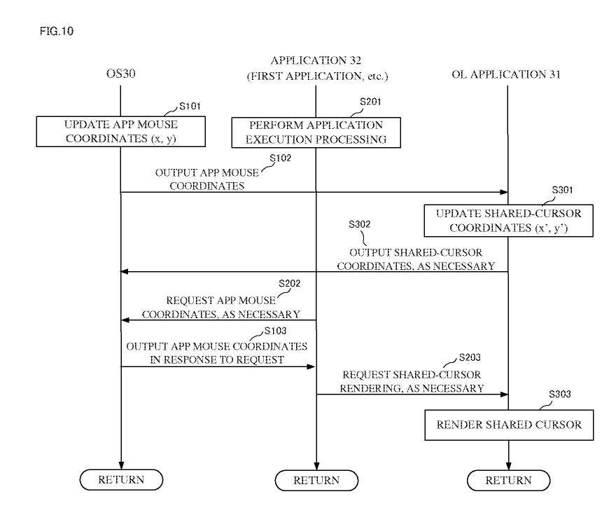

With reference to FIGS. 9 to 10, the information processing in the exemplary embodiment will be described.

### Used Data

Various data stored in the storage section 12 will be described. FIG. 9 shows an example of data stored in the storage section 12 of the game apparatus 10. As shown in FIG. 9, the storage section 12 is provided with at least a program storage area 300 and a data storage area 400.

At least an OS program 301, an OL app program 302, a first app program 303, and a second app program 304 are stored in the program storage area 300. At least mouse sensor data 401, app mouse coordinate data 403, shared-cursor coordinate data 404, button operation data 405, object data 406, image data 407, and virtual camera control data 408 are stored in the data storage area 400.

The OS program 301 is a program for the OS 30. The OL app program 302 is a program for the OL application 31. The first app program 303 is a program for the first application. The second app program 304 is a program for the second application.

The mouse sensor data 401 is data about an output from the mouse sensor 15c and includes dx/dy data 402.

The dx/dy data 402 is the dx/dy data described with reference to FIG. 4.

The app mouse coordinate data 403 is data of the app mouse coordinates (x, y) calculated or corrected by the OS 30, described with reference to FIG. 4 to FIG. 8.

The shared-cursor coordinate data 404 is data of the shared-cursor coordinates (x’, y’) calculated or corrected by the OL application 31, described with reference to FIGS. 4 to 8.

The button operation data 405 is data indicating an operation state of the button 15d.

The object data 406 is data of virtual objects to be disposed in a virtual space, for example, and is data of a player object, a ground object, a building object, and the like to be disposed in a game space.

The image data 407 is image data of the app images and the shared cursor image (see FIG. 5, etc.), and image data of, for example, animation images, backgrounds, virtual effects, and the like in a game image.

The virtual camera control data 408 is data for controlling a virtual camera which is disposed in the virtual space and captures an image of the virtual space.

In addition, various data to be used in rendering processing and the like are stored in the storage section 12, as necessary.

### Detailed Example of Information Processing

Next, processing according to the exemplary embodiment will be described with reference to a flowchart. FIG. 10 is an example of a flowchart showing processing according to the exemplary embodiment, and the flowchart describes processes of the OS 30, the application 32, and the OL application 31 separately. In the following description, processes characteristic to the exemplary embodiment will be mainly described, and description of other matters is basically omitted. Each process may include another process, and in each process, certain processing may be omitted. The order of processing steps is merely an example. For example, some processing steps may be executed at the same time, or may be executed in a reverse order. For the sake of convenience, processing steps are described as divided steps, but they may be integrated processing. The processes shown below are executed at specified intervals (e.g., frame intervals in processing executed per 1/60 seconds).

In step S101, the processor 11 calculates the app mouse coordinates (x, y), based on the dx/dy data 402, and updates the app mouse coordinate data 403, as the process by the OS 30.

In step S102, the processor 11 outputs the app mouse coordinates indicated by the app mouse coordinate data 403 to the OL application 31, as the process by the OS 30.

In step S301, the processor 11 updates, based on the inputted app mouse coordinates, the shared-cursor coordinate data 404 such that the position defined by the app mouse coordinates and the display position defined by the shared-cursor coordinates (i.e., the display position of the tip of the shared cursor) coincide on the display screen (see FIG. 5(3)), as the process by the OL application 31. In addition, as described with reference to FIG. 6, when the display size of the app image is changed within the range of the display screen, the processor 11 updates the shared-cursor coordinate data 404 such that the position defined by the shared-cursor coordinates coincides with the position defined by the app mouse coordinates on the display screen. Furthermore, as described with reference to FIG. 8, when the application as the operation target has been switched and the shared-cursor coordinates are positioned outside the area of the app image of the current operation target, the processor 11 updates the shared-cursor coordinate data 404 such that the position defined by the shared-cursor coordinates becomes the nearest position in the inner edge area of the app image on the display screen.

In step S302, when the shared-cursor coordinates have been updated in step S301, the processor 11 outputs the shared-cursor coordinates to the OS 30, as necessary, as the process by the OL application 31. For example, as described with reference to FIG. 7 and FIG. 8, when the app image of the operation target has been switched, the processor 11 acquires the shared-cursor coordinates and, in step S101, updates the app mouse coordinates.

In step S201, the processor 11 performs an app execution process as the process performed by the application 32 such as the first application and the second application. The app execution process includes, for example, game progress processing by a game application, chat processing between users by a chat application, and setting processing by a setting application.

In step S202, the processor 11 requests the app mouse coordinates from the OS 30, as necessary, as the process by the application 32. For example, the processor 11 requests the app mouse coordinates when an operation using the shared cursor is accepted based on an operation by the user in the first application.

In step S103, the processor 11 outputs the app mouse coordinates indicated by the app mouse coordinate data 403 to the application 32 upon request, as the process by the OS 30.

In step S203, the processor 11 requests that the OL application 31 render the shared cursor, as necessary, as the process by the application 32. For example, the processor 11 requests rendering of the shared cursor when an operation using the shared cursor is accepted based on an operation by the user in the first application.

In step S303, the processor 11 renders the shared cursor as the process by the OL application 31.

### Modifications

In the above exemplary embodiment, the display image displayed on the display screen may be displayed simply in an enlarged manner while maintaining the positional relationship between the app image and the OL image. For example, the display image shown in FIG. 5(3) may be displayed in an enlarged manner such that the area of the button C is displayed in an enlarged manner on the entire display screen. In this case, the display position defined by the app mouse coordinates and the display position defined by the shared-cursor coordinates are not deviated from each other, thus eliminating correction therefor. In this case, the shared cursor is displayed in an enlarged manner as well. In addition, the display image displayed on the display screen may be displayed simply in a reduced manner while maintaining the positional relationship between the app image and the OL image. In this case, the display position defined by the app mouse coordinates and the display position defined by the shared-cursor coordinates are not deviated from each other as well, thus eliminating correction therefor. In this case, the shared cursor is displayed in a reduced manner as well.

In the above exemplary embodiment, a case where the shared-cursor coordinates are corrected, when the display size of the app image is enlarged or reduced within the range of the display image on the display screen, has been described (see FIG. 6). However, in a case where the display size of the app image is enlarged to be larger than the range of the display image of the display screen, the shared-cursor coordinates may be similarly corrected as well.

The request for the app mouse coordinates by the processor 11, as the process by the application 32, may be performed regardless of whether or not an operation using the shared cursor can be accepted.

In the above exemplary embodiment, a case where the size of the first app image differs from the size of the second app image on the display screen is described by way of example (see FIG. 7), but those may be the same. For example, the first application may be a main menu application, the second application may be a setting menu application executed from the main menu, and the main menu displayed in full on the display screen may be shifted to the setting menu that is similarly displayed in full on the display screen. At this time, the shared cursor may be continuously used. In addition, at this time, the shared cursor may be displayed in the duration of switching from the first app image to the second app image, during which all app images are temporarily not displayed on the display screen.

In the above exemplary embodiment, a case where the OL application 31 calculates the shared-cursor coordinates and renders the shared cursor has been described by way of example. However, the calculation of the shared-cursor coordinates may be executed by the OS 30 along with the calculation of the app mouse coordinates, for example. The OL application 31 may acquire the shared-cursor coordinates from the OS 30, and may render the shared cursor in response to a request from the OS 30 or the application 32. In addition, the OL application 31 may be substantially a part of functions of the OS 30.

The game apparatus 10 is merely an example of the information processing apparatus, and the information processing apparatus may be an apparatus in which a game is not executed. Similarly, the information processing system may be a system in which a game is not executed.

The shape of the controller is merely an example, and may be another shape, for example. The controller may not necessarily have all of the operation sections, or may have other operation sections.

The various data in the above exemplary embodiment are merely an example, and in each process, other data converted from the above data, or the like, may be used as appropriate.

The information processing system may include a terminal-side apparatus and a server-side apparatus which can communicate with each other via a network, and at least a part of the series of processes described above may be executed by the server-side apparatus. The server may be composed of a plurality of information processing apparatuses, and the processing may be executed in a shared manner by the plurality of information processing apparatuses.

While the exemplary embodiment and modifications have been described above, it is to be understood that the above description is, in all aspects, merely an illustrative example, and is not intended to limit the scope thereof. In addition, it is to be understood that various improvements and changes can be made to the exemplary embodiment and modifications.

What is claimed is:

1. One or more non-transitory computer-readable storage media having stored therein instructions that, when executed, cause one or more processors to perform operations comprising:
calculating a first designated position in a first coordinate system, based on mouse sensor data of an input apparatus;
outputting the first designated position to a first application, based on a first request by the first application;
calculating a second designated position in a predetermined second coordinate system, based on the first designated position; and
rendering a cursor for pointing to the second designated position, based on a second request by the first application.

2. The one or more non-transitory computer-readable storage media according to claim 1, wherein
the first designated position is a position on an image of the first application, and
the second designated position is a position in which the rendered cursor is in a display image including the image of the first application, and which corresponds to the first designated position.

3. The one or more non-transitory computer-readable storage media according to claim 1, wherein
the first coordinate system is settable by the first application, and
the operations further comprise calculating the second designated position, based on the first coordinate system set by the first application.

4. The one or more non-transitory computer-readable storage media according to claim 1, wherein the operations further comprise calculating the second designated position, based on a position and/or a size of an image of the first application in a display image.

5. The one or more non-transitory computer-readable storage media according to claim 1, wherein the operations further comprise:
shifting a state from a first state in which the cursor is displayed on an image of the first application in a display image, based on a second request by the first application, to a second state in which the cursor is displayed in the display image, based on the second request by a second application; and
when performing the shifting, displaying the cursor at a first position which is a position on an image of the second application in the display image in the second state, and in the display image of the cursor in the first state.

6. The one or more non-transitory computer-readable storage media according to claim 1, wherein the operations further comprise:
shifting a state from a first state in which the cursor is displayed on an image of the first application in a display image, based on a second request by the first application, to a second state in which the cursor is displayed in the display image, based on the second request by the second application; and
when performing the shifting, if a position of the cursor in the display image in the first state is outside an image of the second application in the display image in the second state, displaying the cursor at a first position which is a position of an inner edge area on an image of the second application in the display image.

7. The one or more non-transitory computer-readable storage media according to claim 5, wherein the operations further comprise, when performing the shifting, correcting the first designated position such that the cursor is displayed at the first position.

8. An information processing system comprising one or more processors and one or more non-transitory computer-readable storage media having stored therein instructions that, when executed, cause the one or more processors to perform operations comprising:
calculating a first designated position in a first coordinate system, based on mouse sensor data of an input apparatus;
outputting the first designated position to a first application, based on a first request by the first application;
calculating a second designated position in a predetermined second coordinate system, based on the first designated position; and
rendering a cursor for pointing to the second designated position, based on a second request by the first application.

9. The information processing system according to claim 8, wherein
the first designated position is a position on an image of the first application, and
the second designated position is a position in which the rendered cursor is in a display image including the image of the first application, and which corresponds to the first designated position.

10. A computer implemented method comprising:
calculating a first designated position in a first coordinate system, based on mouse sensor data of an input apparatus;
outputting the first designated position to a first application, based on a first request by the first application;
calculating a second designated position in a predetermined second coordinate system, based on the first designated position; and
rendering a cursor for pointing to the second designated position, based on a second request by the first application.

11. The computer implemented method according to claim 10, wherein
the first designated position is a position on an image of the first application, and
the second designated position is a position in which the rendered cursor is in a display image including the image of the first application, and which corresponds to the first designated position.
